(19) United States
(12) Patent Application Publication
(10) Pub. No.: US 2007/0046583 A1
(43) Pub. Date: Mar. 1, 2007

(54) Plasma display apparatus and method of driving the same

(75) Inventors: Dongki Paik, Seoul (KR); Jongrae Lim, Anyang-si (KR); Tae Heon Kim, Seoul (KR); Wootae Kim, Yongin-si (KR); Sung Chun Choi, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/507,627

(22) Filed: Aug. 22, 2006

(30) Foreign Application Priority Data
Aug. 23, 2005 (KR) 10-2005-0077031

(51) Int. Cl. G09G 3/28

(52) U.S. Cl. 345/68

(57) ABSTRACT

A plasma display apparatus and a method of driving the same are disclosed. The plasma display apparatus includes a drive integrated circuit for supplying a driving voltage to a scan electrode, a scan reference voltage supply unit, a setup supply unit and a sustain pulse supply unit. The scan reference voltage supply unit supplies a first voltage to the drive integrated circuit during a reset period and supplies a scan reference voltage to the drive integrated circuit during an address period. The setup supply unit supplies a pulse gradually rising from the first voltage to a second voltage to the drive integrated circuit during the reset period. The sustain pulse supply unit supplies a sustain pulse of a negative polarity with a negative sustain voltage to the drive integrated circuit during a sustain period.

This Nonprovisional application claims priority under 35 U.S.C. §119(a) on Patent Application No. 10-2005-0077031 filed in Korea on Aug. 23, 2005 the entire contents of which are hereby incorporated by reference.

### BACKGROUND OF THE INVENTION

1. Field of the Invention

This document relates to a display apparatus, and more particularly, to a plasma display apparatus and a method of driving the same.

2. Description of the Background Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs form unit discharge cell or discharge cells. Each of the discharge cell is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultra-violet rays, which thereby cause phosphors formed between the barrier ribs to emit light, thus displaying an image. Since the plasma display panel can be manufactured to be thin and light, it has attracted attention as a next generation display device.

Recently, a negative sustain method has been used as a driving method of a plasma display apparatus using low power. In the negative sustain method, before generating a surface discharge between a scan electrode and a sustain electrode, an opposite discharge occurs between the scan electrode or the sustain electrode and an address electrode.

Charges generated by the opposite discharge functions as a seed charge of the surface discharge such that the surface discharge occurs smoothly.

In the related art negative sustain method, since a negative voltage is applied to the scan electrode and the sustain electrode on a front substrate and a ground level voltage is applied to the address electrode, positive charges move toward the scan electrode and the sustain electrode on the front substrate. As a result, a protective layer made of MgO on the scan electrode and the sustain electrode collides with the positive charges, thereby emitting secondary electrons. The secondary electrons affect the following surface discharge. In other words, the secondary electrons function as a seed charge of the surface discharge, thereby smoothly generating the surface discharge.

The following is a description of a circuit for implementing the negative sustain method of the plasma display apparatus, with reference to FIG. 1.

FIG. 1 illustrates a related art plasma display apparatus.

As illustrated in FIG. 1, the related art plasma display apparatus comprises an energy recovery circuit unit 100, a setup supply unit 110, a scan reference voltage supply unit 120, a drive integrated circuit (IC) unit 130, a set-down supply unit 140 and a scan voltage supply unit 150. The related art plasma display apparatus further comprises a pass bottom switch Q6 connected between the energy recovery circuit unit 100 and the setup supply unit 110, and a seventh switch Q7 connected between the setup supply unit 110 and the drive IC 130.

However, the circuit of FIG. 1 for implementing the negative sustain method is designed to rise a rising pulse from a ground level voltage GND to a high setup voltage without the supply of a setup bias voltage during a setup period of a reset period. Accordingly, it is not easy to apply the related art plasma display apparatus of FIG. 1 using the negative sustain method to a plasma display apparatus having a long-gap structure, in which a distance between a scan electrode supplied with a high setup voltage and a sustain electrode is long.

To solve such a problem, the high setup voltage may be supplied to the scan electrode using the setup bias voltage. However, in such a case, a separate voltage source for supplying the setup bias voltage is required, thereby causing an increase in the manufacturing cost.

Further, the expensive pass bottom switch Q6 for a high voltage is used in the related art plasma display apparatus of FIG. 1, thereby causing an increase in the manufacturing cost.

### SUMMARY OF THE INVENTION

Accordingly, an object of the present invention is to solve at least the problems and disadvantages of the background art.

Embodiments of the present invention provide a plasma display apparatus and a method of driving the same capable of simplifying the configuration of a circuit and reducing the cost.

In an aspect, there is provided a plasma display apparatus comprising a plasma display panel comprising a scan electrode and a sustain electrode, a drive integrated circuit for supplying a driving voltage to the scan electrode, a scan reference voltage supply unit for supplying a first voltage to the drive integrated circuit during a reset period and for supplying a scan reference voltage to the drive integrated circuit during an address period, a setup supply unit for supplying a pulse gradually rising from the first voltage to a second voltage to the drive integrated circuit during the reset period, and a sustain pulse supply unit for supplying a sustain pulse of a negative polarity with a negative sustain voltage to the drive integrated circuit during a sustain period.

In another sect, there is provided a plasma display apparatus comprising a plasma display panel comprising a scan electrode and a sustain electrode, a drive integrated circuit for supplying a driving voltage to the scan electrode, a scan reference voltage supply unit for supplying a first voltage to the drive integrated circuit during a reset period and for supplying a scan reference voltage to the drive integrated circuit during an address period, a setup supply unit for supplying a pulse gradually rising from the first voltage to a second voltage to the drive integrated circuit during the reset period, a first sustain pulse supply unit for supplying a sustain pulse of a negative polarity with a negative sustain voltage to the drive integrated circuit during a sustain period, and a second sustain pulse supply unit for supplying a sustain pulse of a negative polarity with a negative sustain voltage to the sustain electrode during the sustain period, and for supplying a ground level voltage to the sustain electrode during the reset period and the address period.

In still another aspect, there is provided a method of driving a plasma display apparatus comprising supplying a pulse, which rises to a first voltage and then rises from the first voltage to a second voltage with a predetermined slope, to a scan electrode during a reset period, supplying a scan reference voltage to the scan electrode during an address period, supplying a ground level voltage to a sustain electrode during the reset period and the address period, and alternately supplying a sustain pulse of a negative polarity to the scan electrode and the sustain electrode during a sustain period.

### BRIEF DESCRIPTION OF THE DRAWINGS

The invention will be described in detail with reference to the following drawings in which like numerals refer to like elements.

FIG. 1 illustrates a related art plasma display apparatus;

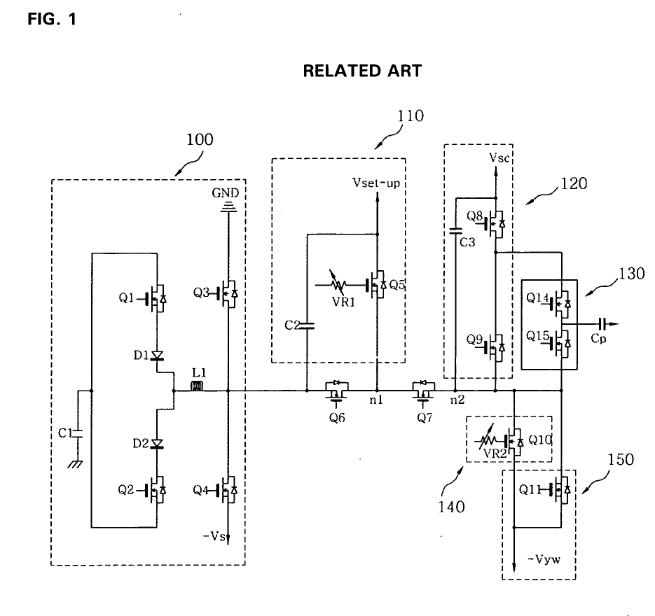

FIG. 2 illustrates an example of the structure of a plasma display panel in a plasma display apparatus according to a first embodiment of the present invention;

FIG. 3 illustrates the plasma display apparatus according to the first embodiment of the present invention;

FIG. 4 illustrates a driving waveform generated by the plasma display apparatus according to the first embodiment of the present invention;

FIG. 5 illustrates a plasma display apparatus according to a second embodiment of the present invention; and

FIG. 6 illustrates a driving waveform generated by the plasma display apparatus according to the second embodiment of the present invention.

### DETAILED DESCRIPTION OF PREFERRED EMBODIMENTS

Preferred embodiments of the present invention will be described in a more detailed manner with reference to the drawings.

A plasma display apparatus according to embodiments of the present invention comprises a plasma display panel comprising a scan electrode and a sustain electrode, a drive integrated circuit for supplying a driving voltage to the scan electrode, a scan reference voltage supply unit for supplying a first voltage to the drive integrated circuit during a reset period and for supplying a scan reference voltage to the drive integrated circuit during an address period, a setup supply unit for supplying a pulse gradually rising from the first voltage to a second voltage to the drive integrated circuit during the reset period, and a sustain pulse supply unit for supplying a sustain pulse of a negative polarity with a negative sustain voltage to the drive integrated circuit during a sustain period.

A magnitude of the first voltage may be substantially equal to a magnitude of the scan reference voltage.

The drive integrated circuit may comprise a top switch and a bottom switch. One terminal of the setup supply unit may be connected to a common terminal of the scan reference voltage supply unit and the top switch of the drive integrated circuit.

The scan reference voltage may be a negative voltage level.

The setup supply unit may comprise a variable resistance.

A distance between the scan electrode and the sustain electrode may range from 100 μm to 400 μm.

A plasma display apparatus according to the embodiments of the present invention comprises a plasma display panel comprising a scan electrode and a sustain electrode, a drive integrated circuit for supplying a driving voltage to the scan electrode, a scan reference voltage supply unit for supplying a first voltage to the drive integrated circuit during a reset period and for supplying a scan reference voltage to the drive integrated circuit during an address period, a setup supply unit for supplying a pulse gradually rising from the first voltage to a second voltage to the drive integrated circuit during the reset period, a first sustain pulse supply unit for supplying a sustain pulse of a negative polarity with a negative sustain voltage to the drive integrated circuit during a sustain period, and a second sustain pulse supply unit for supplying a sustain pulse of a negative polarity with a negative sustain voltage to the sustain electrode during the sustain period, and for supplying a ground level voltage to the sustain electrode during the reset period and the address period.

A magnitude of the first voltage may be substantially equal to a magnitude of the scan reference voltage.

The scan reference voltage may be a negative voltage level.

The drive integrated circuit may comprise a top switch and a bottom switch. One terminal of the setup supply unit may be connected to a common terminal of the scan reference voltage supply unit and the top switch of the drive integrated circuit.

The setup supply unit may comprise a variable resistance.

The plasma display apparatus may further comprise a set-down supply unit for supplying a pulse gradually falling from a ground level voltage to a third voltage to the drive integrated circuit.

The third voltage may range from −800V to −300V.

A distance between the scan electrode and the sustain electrode may range from 100 μm to 400 μm.

A method of driving a plasma display apparatus according to the embodiments of the present invention comprises supplying a pulse, which rises to a first voltage and then rises from the first voltage to a second voltage with a predetermined slope, to a scan electrode during a reset period, supplying a scan reference voltage to the scan electrode during an address period, supplying a ground level voltage to a sustain electrode during the reset period and the address period, and alternately supplying a sustain pulse of a negative polarity to the scan electrode and the sustain electrode during a sustain period.

A magnitude of the first voltage may be substantially equal to a magnitude of the scan reference voltage.

The scan reference voltage may be a negative voltage level.

The method may further comprise supplying a pulse gradually falling from a ground level voltage to a third voltage to the scan electrode, after supplying the pulse, which rises to the first voltage and then rises from the first voltage to the second voltage with the predetermined slope, to the scan electrode during the reset period.

The third voltage may range from −800V to −300V.

A distance between the scan electrode and the sustain electrode may range from 100 μm to 400 μm.

Hereinafter, exemplary embodiments of the present invention will be described in detail with reference to the attached drawings.

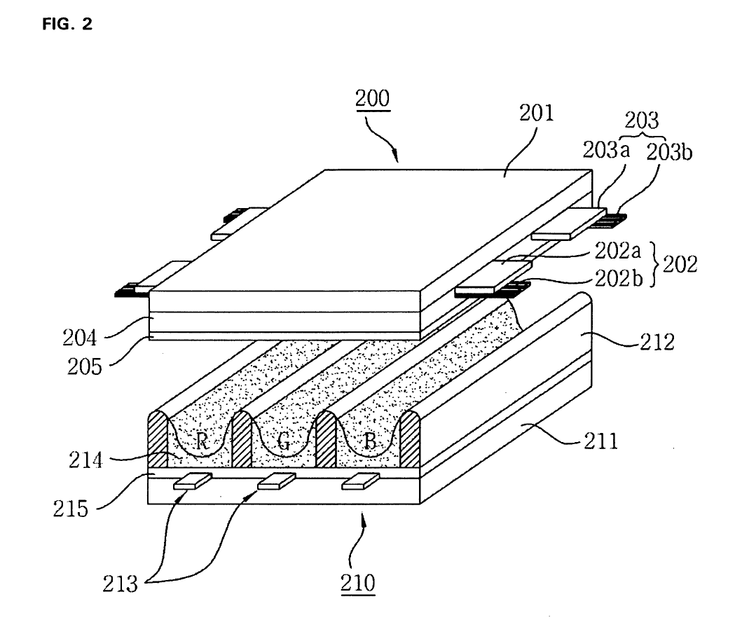

FIG. 2 illustrates an example of the structure of a plasma display panel in a plasma display apparatus according to a first embodiment of the present invention.

As illustrated in FIG. 2, the plasma display panel of the plasma display apparatus according to the first embodiment of the present invention comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed. A plurality of address electrodes 213 are arranged on the rear substrate 211 to intersect the scan electrodes 202 and the sustain electrodes 203.

The scan electrode 202 and the sustain electrode 203 each comprise transparent electrodes 202a and 203a made of transparent indium-tin-oxide (ITO) material and bus electrodes 202b and 203b made of a metal material. The scan electrode 202 and the sustain electrode 203 generate a mutual discharge therebetween in one discharge cell and maintain light-emissions of the discharge cells.

The scan electrode 202 and the sustain electrode 203 are covered with one or more upper dielectric layers 204 to limit a discharge current and to provide insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are formed in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear substrate 211 is coated with Red (R), green (G) and blue (B) phosphors 214 for emitting visible light for an image display when an address discharge is performed. A lower dielectric layer 215 is formed between the address electrodes 213 and the phosphors 214 to protect the address electrodes 213.

An example of the plasma display panel applicable to the first embodiment of the present invention was illustrated in FIG. 2. Accordingly, the embodiment of the present invention is not limited to the structure of the plasma display panel illustrated in FIG. 2.

For example, in FIG. 2, the scan electrode 202 and the sustain electrode 203 each comprise the transparent electrode and the bus electrode. However, at least one of the scan electrode 202 and the sustain electrode 203 may comprise either the bus electrode or the transparent electrode.

Further, the structure of the plasma display panel, in which the front panel 200 comprises the scan electrode 202 and the sustain electrode 203 and the rear panel 210 comprises the address electrode 213, was illustrated in FIG. 2. However, the front panel 200 may comprise all of the scan electrode 202, the sustain electrode 203 and the address electrode 213. At least one of the scan electrode 202, the sustain electrode 203 and the address electrode 213 may be formed on the barrier rib 212.

Considering the structure of the plasma display panel of FIG. 2, the plasma display panel applicable to the first embodiment of the present invention has only to comprise the scan electrode 202, the sustain electrode 203 and the address electrode 213. Accordingly, the plasma display panel may have various structures except the above-described structural characteristic.

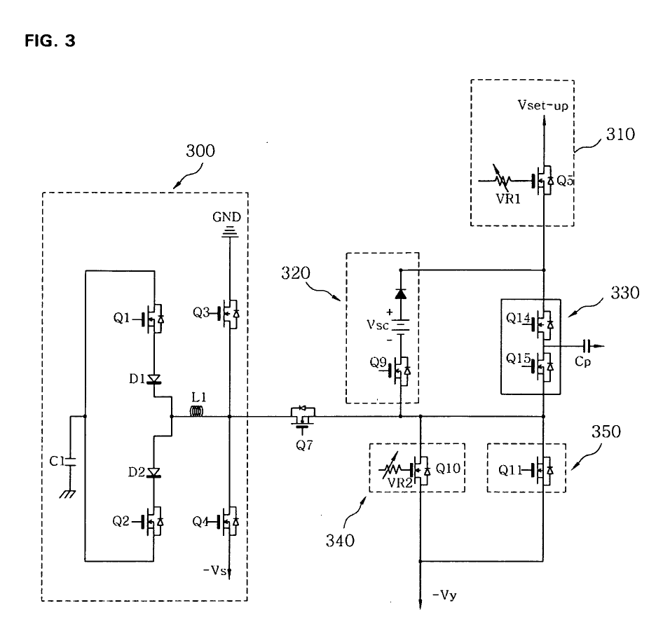

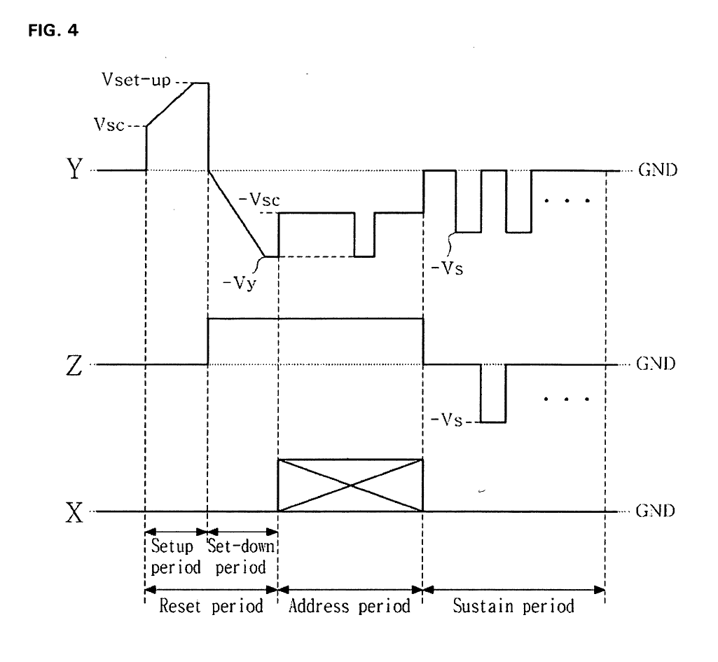

FIG. 3 illustrates the plasma display apparatus according to the first embodiment of the present invention. FIG. 4 illustrates a driving waveform generated by the plasma display apparatus according to the first embodiment of the present invention.

As illustrated in FIGS. 3 and 4, the plasma display apparatus according to the first embodiment of the present invention comprises a sustain pulse supply unit 300, a setup supply unit 310, a scan reference voltage supply unit 320, a drive integrated circuit (IC) unit 330, a set-down supply unit 340 and a scan voltage supply unit 350.

The sustain pulse supply unit 300 comprises a first capacitor C1, a fist inductor L1 and first to fourth switches Q1 to Q4. During a sustain period, the sustain pulse supply unit 300 recovers a voltage stored in the scan electrode of a plasma display panel Cp through resonance between the sustain pulse supply unit 300 and the plasma display panel Cp. The sustain pulse supply unit 300 supplies the recovered voltage to the scan electrode of the plasma display panel Cp, and supplies a sustain voltage −Vs of a negative polarity to the drive IC 330.

Accordingly, a sustain pulse of a negative polarity having the sustain voltage −Vs of the negative polarity is supplied to the drive IC 330.

The setup supply unit 310 comprises a setup voltage source (not shown), a first variable resistance VR1 and a fifth switch Q5. One terminal of the setup supply unit 310 is commonly connected to the scan reference voltage supply unit 320 and a fourteenth switch Q14 of the drive IC 330 such that a pulse (i.e., a setup pulse) gradually rising from a first voltage Vsc to a second voltage Vset-up is supplied to the drive IC 330 during a setup period of a reset period.

Since the fifth switch Q5 performs a function for blocking an inverse current when supplying the second voltage Vset-up in the plasma display apparatus according to the first embodiment of the present invention, the related art pass bottom switch Q6 for the high voltage can be removed.

Accordingly, the plasma display apparatus according to the first embodiment of the present invention can be more efficiently driven while reducing the cost due to the removal of the expensive pass bottom switch Q6 for the high voltage.

The scan reference voltage supply unit 320 comprises a scan reference voltage source (not shown) and a ninth switch Q9. The scan reference voltage supply unit 320 supplies the first voltage Vsc, which is a setup bias voltage, to the drive IC 330 during the reset period, and also supplies a scan reference voltage −Vsc to the drive IC 330 during an address period.

A magnitude of the first voltage Vsc is substantially equal to a magnitude of the scan reference voltage −Vsc. A polarity of the first voltage Vsc is opposite to a polarity of the scan reference voltage −Vsc. That is, the polarity of the scan reference voltage −Vsc is a negative polarity.

As described above, in the plasma display apparatus according to the first embodiment of the present invention, the scan reference voltage source of the scan reference voltage supply unit 320 supplies the fist voltage Vsc, which is the setup bias voltage, during the reset period, and also supplies the scan reference voltage −Vsc during the address period. Accordingly, the setup pulse including the setup bias voltage Vsc (i.e., the first voltage) is supplied to the scan electrode without a separate voltage source.

The drive IC 330 comprises the fourteenth switch Q14 and a fifteenth switch Q15. The drive IC 330 supplies a driving voltage supplied from each of the sustain pulse supply unit 300, the setup supply unit 310, the scan reference voltage supply unit 320, the set-down supply unit 340 and the scan voltage supply unit 350 to the scan electrode Y of the plasma display panel Cp.

The set-down supply unit 340 comprises a second variable resistance VR2 and a tenth switch Q10. The set-down supply unit 340 supplies a pulse (i.e., a set-down pulse) gradually falling from a ground level voltage to a third voltage −Vy to the drive IC 330 during a set-down period of the reset period.

The scan voltage supply unit 350 comprises an eleventh switch Q11. The scan voltage supply unit 350 supplies a scan voltage −Vy that is equal to a magnitude of the third voltage −Vy, to the drive IC 330 during the address period.

Operations of the plasma display apparatus according to the first embodiment of the present invention having the above configuration will be described in detail, with reference to FIG. 4.

During the setup period of the reset period, the fourteenth switch Q14 of the drive IC 330 is turned on. As a result, the first voltage Vsc is supplied to the scan electrode Y of the plasma display panel Cp.

During the setup period of the reset period, the fifth switch Q5 of the setup supply unit 310 is turned on and the fourteenth switch Q14 of the drive IC 330 remains in the turn-on state. As a result, the first variable resistance VR1 installed in a front end of the fifth switch Q5 controls a channel width such that the pulse (i.e., the setup pulse) gradually rising from the first voltage Vsc to the second voltage Vset-up is supplied to the scan electrode Y of the plasma display panel Cp.

During the set-down period of the reset period, the fifth switch Q5 and the fourteenth switch Q14 is turned off and the tenth switch Q10 of the set-down supply unit 340 is turned on. As a result, the second variable resistance VR2 installed in a front end of the tenth switch Q10 controls a channel width such that the pulse (i.e., the set-down pulse) gradually falling from the ground level voltage GND to the third voltage −Vy is supplied to the scan electrode Y of the plasma display panel Cp.

During the address period, the ninth switch Q9 of the scan reference voltage supply unit 320 and the fifteenth switch Q15 of the drive IC are turned on such that the scan reference voltage −Vsc is supplied to the scan electrode Y of the plasma display panel Cp.

During the address period, the ninth switch Q9 of the scan reference voltage supply unit 320 is turned off and the eleventh switch Q11 of the scan voltage supply unit 350 is turned on such that the scan voltage −Vy is supplied to the scan electrode of the plasma display panel Cp.

During the sustain period, the sustain pulse of the negative polarity having the sustain voltage Vs of the negative polarity is supplied to the scan electrode of the plasma display panel Cp through switching operations of the first to fourth switches Q1 to Q4 of the sustain pulse supply unit 300.

It is possible to apply the plasma display apparatus according to the first embodiment of the present invention to a plasma display apparatus having a long-gap structure in which a distance between a scan electrode and a sustain electrode is long.

When applying the plasma display apparatus according to the first embodiment of the present invention to a plasma display apparatus having a long-gap structure, in which a distance between a scan electrode and a sustain electrode substantially ranges from 100 μm to 400 μm, for improving discharge efficiency and stabilizing a driving characteristic, the plasma display apparatus having the long-gap structure is driven more efficiently and more stably.

Further, since the plasma display apparatus having the long-gap structure supplies the high setup voltage, the time required during the reset period can be reduced.

Preferably, a distance between the scan electrode and the sustain electrode substantially ranges from 160 μm to 300 μm.

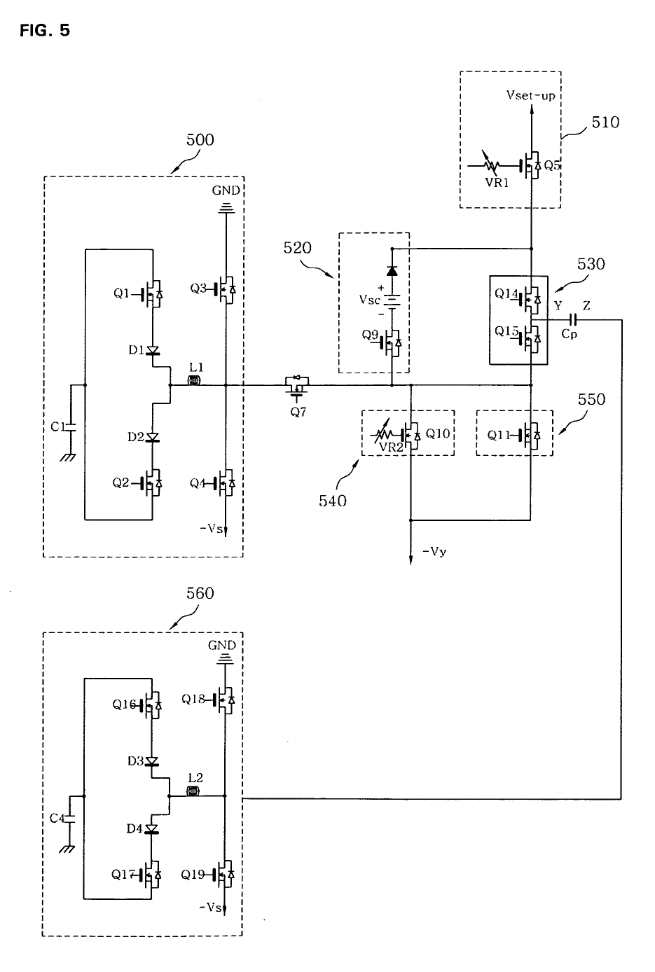

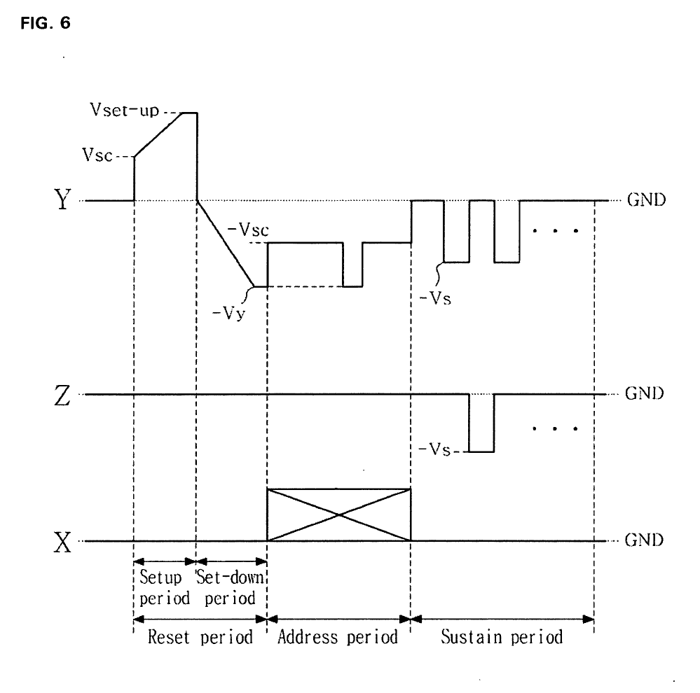

FIG. 5 illustrates a plasma display apparatus according to a second embodiment of the present invention. FIG. 6 illustrates a driving waveform generated by the plasma display apparatus according to the second embodiment of the present invention.

Since the configuration and operations of the plasma display apparatus according to the second embodiment of the present invention in FIG. 5 are the same as the configuration and the operations of the plasma display apparatus according to the first embodiment of the present invention in FIG. 3 except a second sustain pulse supply unit 560, a description thereof will be omitted.

As illustrated FIG. 5, the second sustain pulse supply unit 560 of the plasma display apparatus according to the second embodiment of the present invention comprises a second capacitor C2, a second inductor L2 and sixteenth to nineteenth switches Q16 to Q19. During a sustain period, the second sustain pulse supply unit 560 recovers a voltage stored in a sustain electrode of a plasma display panel Cp through resonance between the second sustain pulse supply unit 560 and the plasma display panel Cp. The second sustain pulse supply unit 560 supplies the recovered voltage to the sustain electrode of the plasma display panel Cp, and supplies a sustain voltage −Vs of a negative polarity to the sustain electrode of the plasma display panel Cp.

Accordingly, a sustain pulse of a negative polarity having the sustain voltage −Vs of the negative polarity is supplied to the sustain electrode of the plasma display panel Cp. During a reset period and an address period, a ground level voltage GND is supplied to the sustain electrode of the plasma display panel Cp.

Unlike the related art plasma display apparatus, a setup pulse supplied to a scan electrode of the plasma display panel Cp rises from a setup bias voltage (i.e., a first voltage Vsc) in the plasma display apparatus according to the second embodiment of the present invention. Accordingly, there is no necessity to supply a setup bias voltage corresponding to the setup pulse to the sustain electrode.

Therefore, a circuit for driving the sustain electrode may be a simple sustain circuit comprising the second sustain pulse supply unit 560. Further, the circuit for driving the sustain electrode and the circuit for driving the scan electrode may be integrated into one driving circuit, thereby simplifying the configuration of the circuit and reducing the manufacturing cost.

As illustrated in FIG. 6, when supplying a falling pulse (i.e., a set-down pulse) gradually falling from a ground level voltage GND to a third voltage −Vy to the scan electrode, a voltage of the scan electrode falls until the time a weak discharge with a negative value occurs. Therefore, although the ground level voltage is supplied to the sustain electrode, a discharge is not influenced.

It is preferable that the third voltage −Vy substantially from −800V to −300V. In such a case, it is possible to apply the plasma display apparatus according to the second embodiment of the present invention to a cell having the long-gap structure.

The plasma display apparatus according to the embodiments of the present invention supplies the setup pulse having the setup bias voltage without a separate voltage source, thereby improving a driving characteristic and reducing the manufacturing cost.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a scan electrode and a sustain electrode;
a drive integrated circuit for supplying a driving voltage to the scan electrode;
a scan reference voltage supply unit for supplying a first voltage to the drive integrated circuit during a reset period and for supplying a scan reference voltage to the drive integrated circuit during an address period;
a setup supply unit for supplying a pulse gradually rising from the first voltage to a second voltage to the drive integrated circuit during the reset period; and
a sustain pulse supply unit for supplying a sustain pulse of a negative polarity with a negative sustain voltage to the drive integrated circuit during a sustain period.

2. The plasma display apparatus of claim 1, wherein a magnitude of the first voltage is substantially equal to a magnitude of the scan reference voltage.

3. The plasma display apparatus of claim 2, wherein the drive integrated circuit comprises a top switch and a bottom switch, and
one terminal of the setup supply unit is connected to a common terminal of the scan reference voltage supply unit and the top switch of the drive integrated circuit.

4. The plasma display apparatus of claim 2, wherein the scan reference voltage is a negative voltage level.

5. The plasma display apparatus of claim 1, wherein the setup supply unit comprises a variable resistance.

6. The plasma display apparatus of claim 1, wherein a distance between the scan electrode and the sustain electrode ranges from 100 μm to 400 μm.

7. A plasma display apparatus comprising:
a plasma display panel comprising a scan electrode and a sustain electrode;
a drive integrated circuit for supplying a driving voltage to the scan electrode;
a scan reference voltage supply unit for supplying a first voltage to the drive integrated circuit during a reset period and for supplying a scan reference voltage to the drive integrated circuit during an address period;
a setup supply unit for supplying a pulse gradually rising from the first voltage to a second voltage to the drive integrated circuit during the reset period;
a first sustain pulse supply unit for supplying a sustain pulse of a negative polarity with a negative sustain voltage to the drive integrated circuit during a sustain period; and
a second sustain pulse supply unit for supplying a sustain pulse of a negative polarity with a negative sustain voltage to the sustain electrode during the sustain period, and for supplying a ground level voltage to the sustain electrode during the reset period and the address period.

8. The plasma display apparatus of claim 7, wherein a magnitude of the first voltage is substantially equal to a magnitude of the scan reference voltage.

9. The plasma display apparatus of claim 8, wherein the scan reference voltage is a negative voltage level.

10. The plasma display apparatus of claim 8, wherein the drive integrated circuit comprises a top switch and a bottom switch, and
one terminal of the setup supply unit is connected to a common terminal of the scan reference voltage supply unit and the top switch of the drive integrated circuit.

11. The plasma display apparatus of claim 7, wherein the setup supply unit comprises a variable resistance.

12. The plasma display apparatus of claim 7, further comprising a set-down supply unit for supplying a pulse gradually falling from a ground level voltage to a third voltage to the drive integrated circuit.

13. The plasma display apparatus of claim 12, wherein the third voltage ranges from −800V to −300V.

14. The plasma display apparatus of claim 7, wherein a distance between the scan electrode and the sustain electrode ranges from 100 μm to 400 μm.

15. A method of driving a plasma display apparatus comprising:
supplying a pulse, which rises to a first voltage and then rises from the first voltage to a second voltage with a predetermined slope, to a scan electrode during a reset period;
supplying a scan reference voltage to the scan electrode during an address period;
supplying a ground level voltage to a sustain electrode during the reset period and the address period; and
alternately supplying a sustain pulse of a negative polarity to the scan electrode and the sustain electrode during a sustain period.

16. The method of claim 15, wherein a magnitude of the first voltage is substantially equal to a magnitude of the scan reference voltage.

17. The method of claim 16, wherein the scan reference voltage is a negative voltage level.

18. The method of claim 15, further comprising supplying a pulse gradually falling from a ground level voltage to a third voltage to the scan electrode, after supplying the pulse, which rises to the first voltage and then rises from the first voltage to the second voltage with the predetermined slope, to the scan electrode during the reset period.

19. The method of claim 15, wherein the third voltage ranges from −800V to −300V.

20. The method of claim 15, wherein a distance between the scan electrode and the sustain electrode ranges from 100 μm to 400 μm.
